(19) United States
(12) Patent Application Publication
(10) Pub. No.: US 2007/0167135 A1
(43) Pub. Date: Jul. 19, 2007

(54) Rf communication system and method

(75) Inventor: Willem Fontijn, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/587,012

(22) PCT Filed: Jan. 19, 2005
(86) PCT No.: PCT/IB05/50217

§ 371 Date: Jul. 21, 2006

(30) Foreign Application Priority Data
Jan. 21, 2004 (EP) 04100178.5
Jul. 21, 2004 (EP) 04103486.9

(51) Int. Cl. H04H 7/00

(52) U.S. Cl. 455/41.2; 455/3.06

(57) ABSTRACT

The present invention relates to an RF communication system and method for control of user devices via wireless RF communication. In order to provide a flexible use and a number of different applications and, in particular, in order to avoid the need for training user devices beforehand and the need of knowledge of the actual meaning of communicated user settings and/or commands to the passive data carrier, an RF communication system is proposed comprising: a user device (6, 7, 11, 12, 13) for reading user settings and/or commands from a passive data carrier (3, 4, 5, 21, 22) via a wireless RF communication including a controller (64) for controlling the user device (6, 12) according to read user settings and/or commands and a programming unit (65) for automatically programming said passive data carrier (3, 4,5, 21, 15 22) via a wireless RF communication with actual user settings and/or commands of the user device (6, 7, 11, 12, 13), and a passive, via a wireless RF communication programmable and readable data carrier (3, 4, 5, 21, 22) including a memory (31) for storing user settings and/or commands.

### FIELD OF THE INVENTION

The present invention relates to an RF communication system and to a corresponding method for control of user devices via a wireless RF communication.

The present invention relates further to a user device for reading user settings and/or commands from a passive data carrier via a wireless RF communication and to a passive, via a wireless RF communication programmable and readable data carrier.

### BACKGROUND OF THE INVENTION

Radio frequency identification (RFID) tags are known and widely used to identify an object or a location. The state of a device containing a reader depends on the detection of specific tags. An application of such RFID tags is, for instance, described in US 2002/0039896 A1 disclosing a system for disabling mobile telephones in circumstances where the use would prejudice the operation of critical systems (e.g. on an airplane or in a hospital), or would irritate others. It includes a pair of RF beacons (active RFID tags) situated at the entrance of the controlled zone. The phone has receivers sensitive to the beacon outputs, and is adapted automatically to shut down into a stand-by state when passing in one direction through the beacons, and to re-activate when passing in the other direction. Thus, by use of the active RFID tags a specific command identification stored therein is transmitted to the phone to switch it into a particular operational mode.

The problem with the applications known from US 2002/0039896 A1 is that the device including the detector or receiver for detecting/receiving the command from the RFID tag needs to know beforehand what to make of the detected or received signal from a specific RFID tag or, more generally, a specific data carrier which can be programmed and read via a wireless RF communication. The device needs to know the data carrier and must be told the settings associated with that data carrier, i.e. each device needs to be trained before it will exhibit the desired functionality.

Another system is known from US 2003/0073411 A1 which discloses a system for automatically applying a user preference from a mobile computing device to an appliance. A mobile computing device, such as a personal digital assistant (PDA), controls appliances like televisions, radios, printers, etc. The control can take several forms including applying preferences to the appliance such as volume level, favorite program, or just activating or deactivating. Thus, a mobile computing device becomes the master of appliances in its environment, controlling content and user preferences.

The problem of a system according to US 2003/0073411 A1 is that, the mobile computing device must know the content of the message sent to the appliance containing the user settings, i.e. there has to be a known meaning like volume level “loud” or a number of the preferred program. Thus, there has to be a common protocol for all devices so that a command for setting a volume level has the same effect on different devices.

### OBJECT AND SUMMARY OF THE INVENTION

It is an object of the present invention to provide an RF communication system and method by which an extensive training of different user devices can be avoided. Further, an appropriate user device and a passive data carrier for use in such a RF communication system shall be provided.

It is a further object of the present invention to provide an RF communication system and method for control of user devices of different types wherein only the user devices need to know the actual meaning of communicated user settings and/or commands and wherein said passive data carrier may be ignorant of the actual meaning of its content.

The objects are achieved according to the present invention by an RF communication system as claimed in claim 1 comprising:

a user device for reading user settings and/or commands from a passive data carrier via a wireless RF communication including a controller for controlling the user device according to read user settings and/or commands and a programming unit for automatically programming said passive data carrier via a wireless RF communication with actual user settings and/or commands of the user device, and

a passive, via a wireless RF communication programmable and readable data carrier including a memory for storing user settings and/or commands.

A corresponding RF communication method is defmed in claim 12 comprising the steps of:

automatically programming a passive data carrier via a wireless RF communication with actual user settings and/or commands of a user device, said passive data carrier including a memory for storing said user settings and/or commands,

reading user settings and/or commands from said passive data carrier via a wireless RF communication, and

controlling the user device according to read user settings and/or commands. It has to be noted that the step of automatically programming said passive data carrier may also be performed after the steps of reading user settings and/or commands and controlling the user device instead of being the first step.

An appropriate user device for use in a RF communication system according to the invention is defmed in claim 13 comprising:

an RF transmitter for emitting RF signals,

a programming unit for automatically programming said passive data carrier via said RF signals with actual user settings and/or commands of the user device,

a detector for detecting RF signals or RF signal modulations of the emitted RF signals from said data carrier,

a processor for processing the detected RF signals or RF signal modulations and for deriving user settings and/or commands embedded therein, and

a controller for controlling the user device according to read user settings and/or commands.

A passive, via a wireless RF communication programmable and readable data carrier according to the present invention is defined in claim 14 comprising:

a memory for storing user settings and/or commands,

a receiving means for receiving RF signals,

a processing means for processing said received RF signals to obtain user setting and/or commands embedded therein and/or for embedding stored user settings and/or commands into output RF signals or RF signal modulations of said received RF signals, and

an output means for outputting said output RF signals or RF signal modulations.

The present invention is based on the idea to store user settings and/or commands in the passive data carrier. The passive data carrier then communicates stored commands and/or settings to the user device being within its control area, which device then executes the commands or is controlled according to the read user settings. The data carrier can, for instance, be embedded in the environment, e.g. sealed into a wall, and the user device generally can be any portable or mobile device, such as a mobile phone, a camera, an audio or video device or any other device for domestic appliance. The data carrier may also be a mobile one while the user device can be any device which may be controlled by a user.

The programming of the passive data carrier by the user settings and/or commands is done automatically and implicitly, for instance by communicating the present state, e.g. the volume level and the tuned radio station of an audio device, to the passive data carrier when the passive data carrier and the user device are getting within control range or when changing the state. Next time the same device (or the same type of device) gets into the control range these user settings and/or commands will then be read by the user device which is then automatically controlled to get into the same state.

The selective execution of the transmitted command and/or user settings can be made dependent on the detection of a specific passive data carrier. Thus, commands and/or user settings can be targeted to a specific user device, e.g. the settings and/or commands only apply to the user device that left the user settings and/or commands, or a specific group of devices, e.g. all devices of a particular user or all devices of a particular type.

By the invention it is thus not required to pre-program all user devices by specific commands to be executed when a user device enters the control zone of a particular passive data carrier. Instead, user settings and/or commands are pre-programmed or programmed during use into the data carriers, and the user devices are adapted for being controlled according to such user settings and/or commands which are directed to them.

The invention also permits a user to take his personal user settings and/or commands for control of user devices with him as this data is transmitted from the passive data carrier associated to the user to the user devices within control range so that the user devices are controlled to a state preferred by the user.

Preferred embodiments of the invention are defined in the dependent claims. For enabling an explicit programming of a passive data carrier a separate programming device is provided according to a preferred embodiment which comprises an input means for inputting user settings and/or commands. In addition, also the user device may comprise such input means in order to enable the user to explicitly program a passive data carrier via a user device.

The passive data carrier can generally be any data carrier which is programmable and readable via a wireless RF communication. Preferably, the data carrier comprises:

a receiving means for receiving RF signals,

a processing means for processing said received RF signals to obtain said user setting and/or commands embedded therein and/or for embedding stored user settings and/or commands into output RF signals or RF signal modulations of said received RF signals, and

an output means for outputting said output RF signals or RF signal modulations.

Preferably, a passive RFID tag is used as said passive data carrier. Such passive RFID tags operate without a separate external power source and obtain operating power generated from the reader. Passive RFID tags are thus much lighter than active tags, less expensive, and offer a virtually unlimited operational life time. Generally, the read range, i.e. the control zone controlled by such a passive RFID tag, is several meters, for instance 10 m. The general layout and function of such passive RFID tags is commonly known in the art and shall not be explained further here.

Said passive data carrier can be integrated into a mobile user apparatus, in particular into a mobile phone, a transponder, a SmartCard or a PDA. Users commonly carry at least one such apparatus with them, so it might also be used as a passive data carrier according to the present invention. It is possible for a user to control user devices according to his personal user settings stored in said passive data carrier, even if the meaning of that data is not explicitly known to said data carrier. If in the following a tag is mentioned this includes also passive data carriers integrated into mobile user apparatus.

User devices particularly adapted for use with said passive data carrier, in particular such RFID tags, comprise:

an RF transmitter for emitting RF signals,

a detector for detecting RF signals or RF signal modulations of emitted RF signals,

a processor for processing the detected RF signals or RF signal modulations and for deriving user settings and/or commands embedded therein.

As already mentioned not only one particular command or user setting can be stored in a passive data carrier but different sets which are provided for control of different types, groups or items of user devices. It is also possible to store only command or user settings related to only one user in a passive data carrier associated to said one user. This enables a wide use of the invention for a number of different applications.

Said user device may further comprise an identification means for embedding identification information identifying said user device and/or the type of said user device into RF signals emitted by said RF transmitter. Thus, emitted RF signals comprise information on the specific user device or of the specific type of user device form which they are emitted.

A processing means of said passive data carrier can comprise an identifier means for processing said received RF signals to obtain identification information identifying said user device and/or the type of said user device. It can further comprise a selecting means for selecting stored user settings and/or commands related to said type or said user device to be embedded into said output RF signals or said RF signal modulations of said received RF signals by said processing means. Said processing means comprising said identifier means and said selecting means allows different user devices or types of user devices to be incorporated into the RF communication system of the present invention as there may be different set of data without interference between this data. Thus, for example, user settings related to a radio receiver are not transmitted to a coffee machine.

In a preferred application a plurality of passive data carriers positioned at different locations for control of user devices present in respective control areas around said different locations according to stored user settings and/or commands are provided. For instance, a number of such passive data carriers, e.g. RFID tags, can be located at the walls of a room all storing the same user settings and/or commands, while all data carriers located in another room store a different set of user settings and/or commands.

In another preferred application a plurality of passive data carriers are associated to different users for control of user devices according to stored user settings and/or commands.

### BRIEF DESCRIPTION OF THE DRAWINGS

The invention will now be explained in more detail with reference to the drawings in which

FIG. 1 illustrates a first embodiment for the use of the invention,

FIG. 2 shows a block diagram of a passive data carrier according to the invention used in the first embodiment,

FIG. 3 shows a block diagram of a user device according to the present invention used in the first embodiment,

FIG. 4 shows a block diagram of a programming device according to the present invention,

FIG. 5 illustrates a second embodiment for the use of the invention,

FIG. 6 shows a block diagram of a passive data carrier according to the invention used in the second embodiment,

FIG. 7 shows a block diagram of a user device according to the present invention used in the second embodiment, and

FIG. 8 shows a block diagram of a memory of a passive data carrier according to the invention.

### DESCRIPTION OF PREFERRED EMBODIMENTS

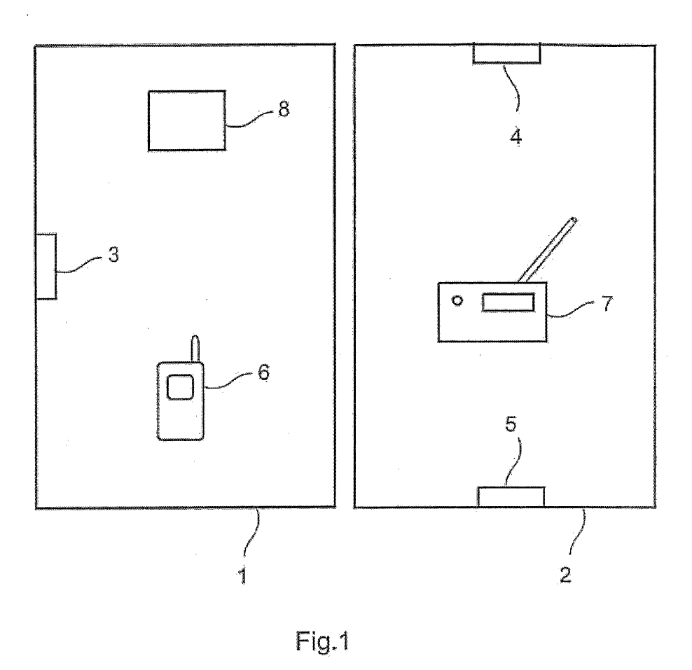

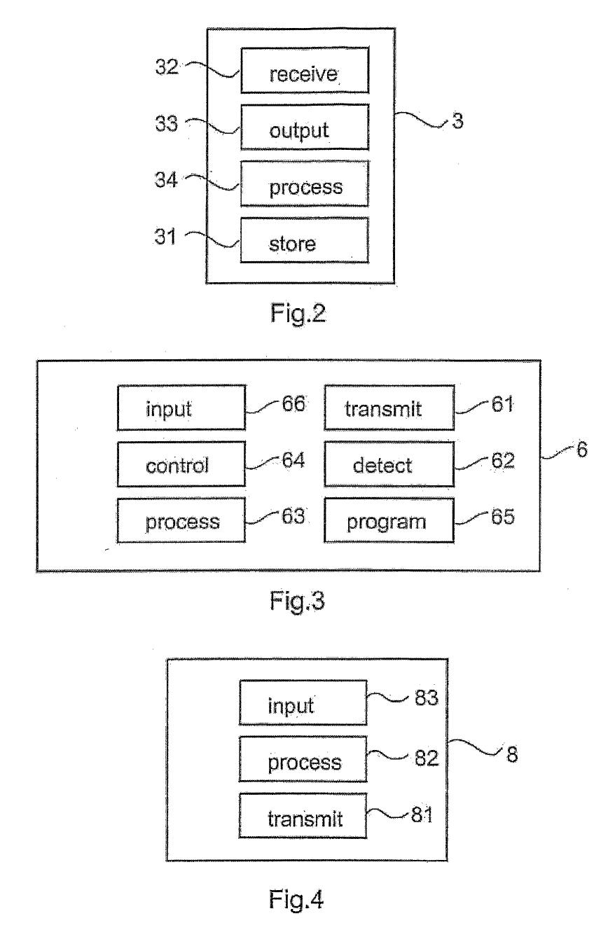

FIG. 1 schematically shows a first embodiment for the use of the present invention. As an example two rooms 1, 2 are shown, both provided with one or more RFID tags 3, 4, 5. The read range, i.e. the control zone, of the RFID tags 3, 4, 5 is adapted such that the complete room 1 lies within the control zone of the tag 3, and that the complete room 2 lies within the control zone of tags 4 and 5. Further, two user devices, in particular a mobile phone 6 and an audio device 7, are exemplary shown. For explicit programming of the tags 3, 4, 5 a programming device 8 is provided. Details of the tags 3, 4, 5 and the devices 6, 7, 8 will be explained below with reference to FIGS. 2 to 4. While in FIGS. 2 and 3 block diagrams of the tag 3 or the user device 6, respectively, are shown as examples, the other tags 4, 5 or the other user device 7, respectively, have the same or similar structure.

According to the present invention user settings and/or commands are stored in a storage unit 31 (see FIG. 2) of the tag 3. The storage unit 31 can be separated into sub-units for storage of different sets of user settings and/or commands provided for different types, groups or items of user devices. For instance, there can be a sub-unit storing user settings and/or commands for mobile phones and a different sub-unit for storing user settings and/or commands for audio devices. Still further, a sub-unit can be provided for storing user settings/commands for a particular user device of a particular user. Alternatively, different tags are used for different devices, device types, groups of devices, users, user types, user groups, since the tags are supposed to be cheap.

When a user device, for instance as shown in FIG. 1 the mobile phone 6, enters the room 1, i.e. the control zone of the tag 3, the receiver 32 of the tag 3 receives RF signals emitted by an RF transmitter 61 of the device 6. For instance, the transmitter 61 continuously generates an RF carrier sine wave, which is used to transmit energy to the passive RFID tag and retrieve data therefrom. These sine waves are induced into the receiver 32, generally a wound or printed coil. Once the tag 3 has received sufficient energy to operate correctly, it divides down the carrier and begins clocking its data stored in the memory 31 to an output unit 33, generally an output transistor which is normally connected across the coil input. The tag's output transistor shunts the coil, sequentially corresponding to the data which is being clocked out of the memory 31, which causes a momentary fluctuation (dampening) of the carrier wave, which is seen as a slight change in amplitude of the carrier, i.e. RF signal modulations are preferably effectuated.

A detector 62 of the user device 6 is able to peak-detect the amplitude-modulated data which can then be processed by a processing unit 63. In particular, user settings and/or commands embedded in the detected RF signal modulations, which are directed for use by this particular user device 6, are retrieved therefrom and provided to a controller 64 for control of the user device 6.

For instance, the data stored in the memory 31 of the tag 3 may include the command that any mobile phone 6 being in the control zone of the tag 3. shall be switched to vibration mode instead of the normal ring mode since any disturbing noise shall be avoided in this room 1, being for instance an exhibition room of a museum or a church. The controller 64 can further be adapted such that the mobile phone 6 returns back to the previous operational mode when it leaves the control zone of the tag 3, i.e. when it leaves the room 1.

The user device 6 is further provided with a programming unit 65 for programming tags and an input unit 66 for inputting user settings and/or commands for control of the user device 6. For instance, when entering the room 1 or when already being within the room 1, the user of the mobile phone 6 may switch the phone 6 to 30 vibration mode or completely switch the phone 6 off manually by use of the mobile phone's terminal. This state will then automatically be programmed into the tag 3 by use of the programming unit 65, in particular by transmitting RF signals by the transmitter 61. These RF signals carry an appropriate information, which can be detected by the receiver 32 and processed by a processing unit 34 of the tag 3 in order to be stored in the memory 31. The mobile phone 6 may then be removed from the room 1 and brought into another state at another location, for instance in the room 2 the mobile phone 6 is again switched on or switched into normal operational mode. Upon the return of the mobile phone 6 back to room 1 again the last state of the mobile phone 6 still stored in the memory 31 will be detected causing it to revert to the programmed setting for this room 1, i.e. the mobile phone 6 is again automatically switched off or switched to vibration mode, respectively.

Also, if another similar device, i.e. another mobile phone, is brought into the room 1, it will interprete the detection of the programmed tag as a command to get into the state left by the previous mobile phone 6 in the tag 3.

In another scenario, for instance in room 2, which may be a sleeping room, the tags 4, 5 may be programmed to set a maximum volume command. Each user device, for instance the audio device 7, entering the room 2 will then read out the tags 4, 5 (or at least one of the tags, both storing the same data) and the maximum volume command will cause the audio device 7 to reduce the volume to the stored maximum level.

In another embodiment tags in the entrance of a church may comprise a special serial number, which has been defined in a standard/specification for mobile phones as silent command. Each mobile phone of a person entering the church will read out the serial number and change to silent mode until the special serial number of a tag sealed in the wall at the exit will turn the mobile phone to normal mode again.

As will be clear from the last two examples there will be portions of data stored in the memory of a tag which can be changed by a user or a user device, while other parts (for instance the maximum volume command or the silent mode command) can not be changed.

In addition to the user devices 6 and 7, there may also be provided a separate programming devices 8 comprising a transmitter 81, a processor 82 and an input unit 83 similar and having the same function as in the user device 6. By such a programming device 8 certain user settings or commands, for instance the silent mode command in the last example, can be explicitly programmed into particular tags.

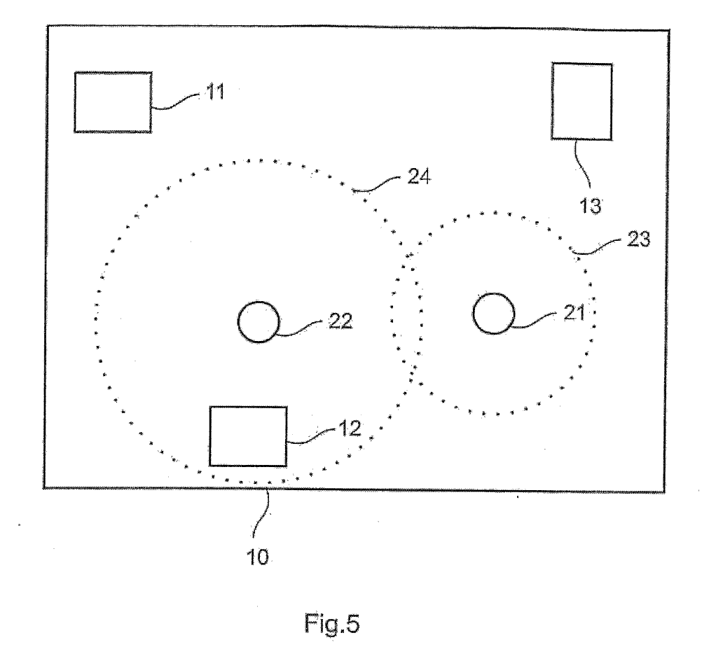

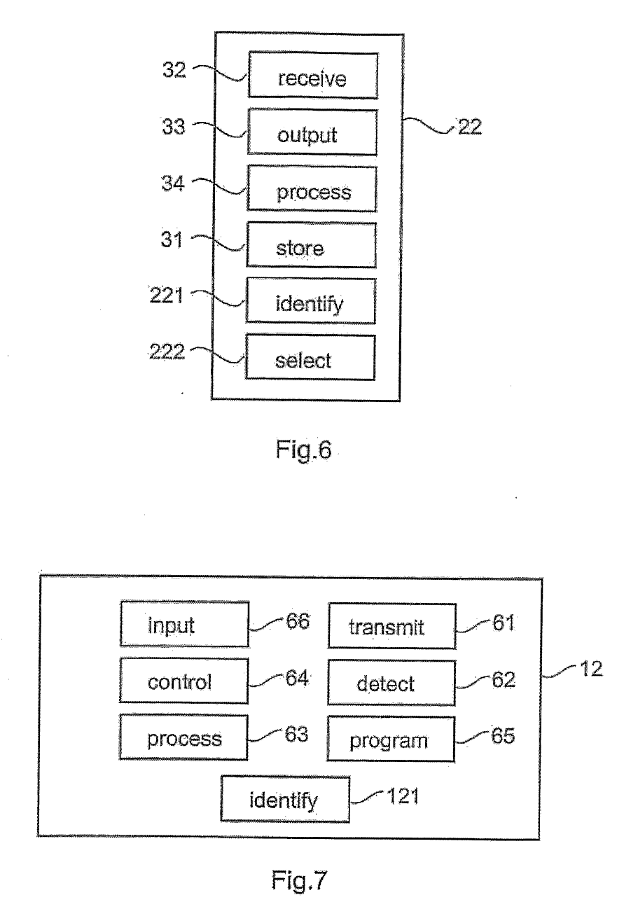

FIG. 5 schematically shows another embodiment for the use of the present invention. As an example a room 10 with different user devices 11, 12, 13 and different passive data carriers 21, 22 associated with different users are shown. Details of the user devices 11, 12, 13 and the passive data carriers 21, 22 will be explained below with reference to FIGS. 6 and 7. While in FIGS. 6 and 7 block diagrams of the user device 11 or the passive data carrier 21, respectively, are shown as examples, the other user devices 12, 13 or passive data carrier 22, respectively, have the same or similar structure.

The way the user devices are controlled according to the embodiment shown in FIG. 5 is substantially the same as described above with reference to FIGS. 1 to 4, and the user devices and passive data carriers have corresponding features. The main difference to the above description is that the passive data carriers of the embodiment illustrated in FIG. 5 are mobile rather than having a fixed location.

There are control ranges 23, 24 around each passive data carrier 21, 22. When a user provided with a passive data carrier 21, 22 comes near to a user device 11, 12, 13 the user device 11, 12, 13 will be inside the control range, as shown with passive data carrier 22 and user device 12. The control ranges 23, 24 may be of different sizes.

When the user device 12 is within the control range 24 of passive data carrier 22 a communication similar to that described above with reference to FIGS. 1 to 3, will take place. In addition to the means of user device 6 the user device 12 further comprises an identification means 121 for embedding identification information identifying said user device 12 and/or the type of said user device 12 into said RF signals. These signals are received by said passive data carrier 22 similar to the one described above with reference to FIG. 2 further comprising an identifier means 221 and a selecting means 222. The received signals are processed by the identifier means 221 to obtain said identification information. Stored user settings and/or commands related to the identified user device 12 are then selected by a selecting means 222 from the memory 31 and outputted by said passive data carrier 22 to said user device 12. User settings and/or commands related to the identified user device 12 and transmitted from user device 12 to the passive data carrier 22 may also be stored in the memory 31 in a sub-unit related to the user device 12 or the type of the user device 12.

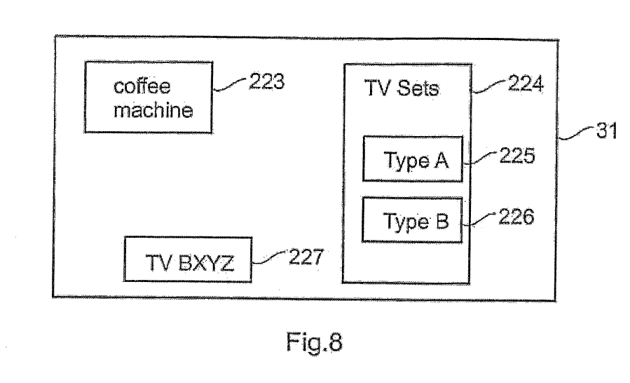

For example, the user device 11 may be a coffee machine, the user device 12 may be a TV set of type A and the user device 13 may be a TV set of type B with the ID BXYZ. The passive data carrier 22 provided to store user settings and/or command to control all these user devices 11, 12, 13 has sub-units 223, 224 for coffee machines and TV sets, as shown in FIG. 8. The sub-unit 224 for TV sets is further divided into sub-units 225, 226 for TV sets of type A and B. There is another sub-unit 227 for a TV set with the ID BXYZ, which may also be a sub-unit of sub-unit 226.

If there is a TV set of any type present in the control range of the passive data carrier 22, that TV set will be controlled according to the user settings and/or commands stored for TV sets in general. If a present user device 13 is recognized for example as a TV set of the type B it will further receive user settings and/or commands stored for type B in addition to the user settings and/or command for TV set in general. If there are user settings and/or commands stored for a special TV set, as indicated by its ID BXYZ, only the TV Set with the respective ID will be controlled according to the respectively stored user settings and/or commands. Further, there is the possibility for user devices 11, 12, 13 to program a passive data carrier 22 while storing user settings and/or commands in different sub-units 224, 225, 226 depending of the types of user devices the user settings and/or commands shall be shared with.

It is preferred that the passive data carrier 21, 22 can divide its total memory in new sub-units related to a new user device or new type of user device after a first encounter with that user device or type.

Other examples for use of the invention include the setting up of a synchronization zone. The command communicated by the tag may be used to initiate a synchronization procedure. Such a set up is expected to be less complex and use less power than the continuous scanning of the environment by a user device to detect synchronization opportunities. The alternative is that the user always initiates the synchronization himself. This embodiment also makes selective initiation of the synchronization procedure possible by attaching an identifier to the command, e.g. a particular mobile device only initiates synchronization if it detects a particular assigned identifier in combination with the synchronisation command.

The proposed invention of programming passive data carriers, in particular passive RFID tags provides a flexible use and a wide range of applications. Desired user settings and/or commands can be specified and stored in the tag, and all other user devices can read it, not only the one user device that stored the information, but all other user devices to which it is directed. Commands or user settings for other types or instances of devices can be left, and it is not required to program the response to a specific identifier into the user devices that need to respond to the tag. In particular, an extensive training of user devices is not required according to the present invention.

1. RF communication system for control of user devices via a wireless RF communication comprising:
a user device for reading user settings and/or commands from a passive data carrier via a wireless RF communication including a controller for controlling the user device according to read user settings and/or commands and a programming unit for automatically programming said passive data carrier via a wireless RF communication with actual user settings and/or commands of the user device, and
a passive, via a wireless RF communication programmable and readable data carrier including a memory for storing user settings and/or commands.

2. RF communication system as claimed in claim 1, further comprising a programming device having an input means for inputting user settings and/or commands for explicitly programming said passive data carrier.

3. RF communication system as claimed in claim 1, wherein said passive data carrier further comprises:
a receiving means for receiving RF signals,
a processing means for processing said received RF signals to obtain said user settings and/or commands embedded therein and/or for embedding stored user settings and/or commands into output RF signals or RF signal modulations of said received RF signals, and
an output means for outputting said output RF signals or RF signal modulations.

4. RF communication system as claimed in claim 3, wherein said passive data carrier is a passive RFID tag.

5. RF communication system as claimed in claim 3, wherein said passive data carrier is integrated into a mobile user apparatus, in particular into a mobile phone, a transponder, a SmartCard or a PDA.

6. RF communication system as claimed in claim 3, wherein said user device further comprises:
an RF transmitter for emitting RF signals,
a detector for detecting RF signals or RF signal modulations of emitted RF signals,
a processor for processing the detected RF signals or RF signal modulations and for deriving user settings and/or commands embedded therein.

7. RF communication system as claimed in claim 1, wherein said passive data carrier is adapted for storing a number of different sets of user settings and/or commands for control of different types or selected user devices.

8. RF communication system as claimed in claim 6, wherein said user device further comprises an identification means for embedding identification information identifying said user device and/or the type of said user device into RF signals emitted by said RF transmitter.

9. RF communication system as claimed in claim 6, wherein said processing means of said passive data carrier further comprises:
an identifier means for processing said received RF signals to obtain identification information identifying said user device and/or the type of said user device and
a selecting means for selecting stored user settings and/or commands related to said type or said user device to be embedded into said output RF signals or said RF signal modulations of said received RF signals by said processing means.

10. RF communication system as claimed in claim 1, comprising a plurality of passive data carriers positioned at different locations for control of user devices present in respective control areas around said different locations according to stored user settings and/or commands.

11. RF communication system as claimed in claim 1, comprising a plurality of passive data carriers associated to different users for control of user devices according to stored user settings and/or commands.

12. RF communication method for control of user devices via a wireless RF communication comprising the steps of:
automatically programming a passive data carrier via a wireless RF communication with actual user settings and/or commands of a user device, said passive data carrier including a memory for storing said user settings and/or commands,
reading user settings and/or commands from said passive data carrier via a wireless RF communication,
controlling the user device according to read user settings and/or commands.

13. User device for use in a RF communication system as claimed in claim 1 for reading user settings and/or commands from a passive data carrier via a wireless RF communication, comprising:
an RF transmitter for emitting RF signals,
a programming unit for automatically programming said passive data carrier via said RF signals with actual user settings and/or commands of the user device
a detector for detecting RF signals or RF signal modulations of the emitted RF signals from said data carrier,
a processor for processing the detected RF signals or RF signal modulations and for deriving user settings and/or commands embedded therein, and
a controller for controlling the user device according to read user settings and/or commands.

14. Passive, via a wireless RF communication programmable and readable data carrier for use in a RF communication system as claimed in claim 1 comprising:
a memory for storing user settings and/or commands,
a receiving means for receiving RF signals,
a processing means for processing said received RF signals to obtain user setting and/or commands embedded therein and/or for embedding stored user settings and/or commands into output RF signals or RF signal modulations of said received RF signals, and
an output means for outputting said output RF signals or RF signal modulations.
